(19) United States
(12) Patent Application Publication
(10) Pub. No.: US 2026/0018808 A1
(43) Pub. Date: Jan. 15, 2026

(54) CONDUCTOR CONNECTION TERMINAL FOR CONNECTING AN ELECTRICAL CONDUCTOR

(71) Applicant: WAGO Verwaltungsgesellschaft mbH, Minden (DE)

(72) Inventors: Thomas WITTE, Porta Westfalica (DE); Christian ARNDT, Bielefeld (DE); Muhammet Ali TÜRKEKÖLE, Minden (DE)

(73) Assignee: WAGO Verwaltungsgesellschaft mbH, Minden (DE)

(21) Appl. No.: 19/264,793

(22) Filed: Jul. 9, 2025

(30) Foreign Application Priority Data
Jul. 10, 2024 (DE) 20 2024 103 826.6

(51) Int. Cl. H01R 4/2445; H01R 4/2429

(52) U.S. Cl. CPC H01R 4/2445; H01R 4/2429

(57) ABSTRACT

A conductor connection terminal is provided for connecting an electrical conductor which is to be inserted into the conductor connection terminal in a conductor insertion direction. At least one insulation displacement connector is provided with opposing cutting edges, between which a cutting gap is formed. At least one pressure spring is designed to press the electrical conductor into the cutting gap via a spring force. At least one holding device is designed to hold the pressure spring in a pretensioned state in which a spring force is present for pressing the electrical conductor into the cutting gap. At least one release element, by actuation of which the pressure spring can be released from the holding device so that the electrical conductor can be pressed into the cutting gap by its spring force.

This nonprovisional application claims priority under 35 U.S.C. § 119 (a) to German Patent Application No. 20 2024 103 826.6, which was filed in Germany on Jul. 10, 2024, and which is herein incorporated by reference.

### BACKGROUND OF THE INVENTION

### Field of the Invention

The invention relates to a conductor connection terminal for connecting an electrical conductor which is to be inserted into the conductor connection terminal in a conductor insertion direction.

### Description of the Background Art

Conductor connection terminals are known in many different forms, e.g., with a spring-loaded clamping connection. A connection device for connecting a conductor with a self-actuating piercing contact is known from EP 1 463 152 B1.

### SUMMARY OF THE INVENTION

It is therefore an object of the invention to provide a further improved conductor connection terminal.

This object is achieved in an example, by providing a conductor connection terminal for connecting an electrical conductor which is to be inserted into the conductor connection terminal in a conductor insertion direction, having at least one insulation displacement connector with opposing cutting edges, between which a cutting gap is formed, at least one pressure spring which is designed to press the electrical conductor into the cutting gap by means of a spring force, at least one holding device which is designed to hold the pressure spring in a pretensioned state in which a spring force is present for pressing the electrical conductor into the cutting gap, and at least one release element, by actuation of which the pressure spring can be released from the holding device so that the electrical conductor can be pressed into the cutting gap by its spring force.

At least part of the pressure spring can be displaced relative to the insulation displacement connector in the conductor insertion direction by actuating the release element. This allows a particularly compact and therefore small design of a conductor connection terminal with an insulation displacement connector and automatic release technology. The conductor connection terminal can be realized with a small number of components and can therefore be manufactured relatively inexpensively. The cutting gap or the plane spanned by the cutting edges can be arranged, e.g., substantially orthogonal to the conductor insertion direction. Advantageously, the release element can be designed to be actuated in an actuation direction that runs in alignment or parallel to the conductor insertion direction or at a relatively small angle, in particular less than 15 degrees, to the conductor insertion direction.

In an open position of the insulation displacement connector, the pressure spring is pretensioned and held on the holding device, e.g., by holding the pressure section on the holding device. The insulation displacement connection, which can also be referred to as an IDC connector, is designed to make direct electrical contact with an electrical conductor provided with an insulating covering without prior stripping. This is done by pressing the electrical conductor with its insulation sheath into the cutting gap through the cutting edges, which cut open the insulation and establish electrical contact with the inner conductor. The cutting edges can be formed, e.g., fork-shaped.

The release element can be formed as an integral structural unit with the pressure spring, in particular that the pressure spring is formed as a one-piece structural unit with the release element, in particular as a sheet metal component. This is particularly beneficial for the design of the conductor connection terminal in a small, compact form. The release element can be designed as a separate component from the pressure spring. In this case, the release element is designed as an integral structural unit with a connection technology, e.g., by screwing, riveting, and/or bonding, and/or by a positive connection with the pressure spring. In an example, the pressure spring can be formed in one piece with the release element, e.g., as a sheet metal component. For example, the pressure spring with the release element can be formed as a press-bent sheet metal component.

The pressure spring can have a pressure section, which comes into contact with the electrical conductor in order to press it into the cutting gap, and a fastening section with which the pressure spring is fastened to a part of the insulation displacement connector or to another component of the conductor connection terminal. The pressure section therefore comes into direct physical contact with the electrical conductor; i.e., it directly transfers the pressure force to the electrical conductor. The pressure spring can be fixed against the spring force of the pressure section via the fastening section. For example, the fastening section can be positively coupled to a base section of the insulation displacement connector.

The release element can be disposed between the fastening section and the pressure section. In this way, the release section is structurally integrated at a central point in the pressure element. If the pressure element is formed as a one-piece sheet metal component with the release element as previously mentioned, this sheet metal component can extend from the fastening section to the release element and then from the release element further to the pressure section. In this regard, the release element can also generate part of the spring force of the pressure spring.

The pressure section can be connected to the fastening section via the release element.

The conductor connection terminal can have an outer spring, by means of which the cutting edges can be subjected to a spring force in directions pointing towards each other. This can ensure the desired cutting pressure and contact pressure of the insulation displacement connector, which is particularly helpful if the insulation displacement connector is made of a material that has no or only relatively low resilient properties.

The outer spring can be formed in one piece with the pressure spring and/or the release section. In this way, the outer spring can be advantageously integrated into the integral structure of the pressure spring and the release element. For example, the outer spring can also be formed as part of the press-bent sheet metal component. Alternatively, the outer spring can be disposed as a separate component on the pressure spring and/or on the insulation displacement connector.

The insulation displacement connector can have at least two insulation displacement arms, wherein a cutting edge of the insulation displacement connector is disposed on each insulation displacement arm. This allows a simple and cost-effective production of the insulation displacement connector. The insulation displacement arms can be arranged parallel to each other.

For example, the outer spring can have spaced-apart pressure tabs which project from the release section in the opposite direction to the conductor insertion direction and engage over the insulation displacement arms of the insulation displacement connector from the outside. The pressure tabs can, e.g., be bent away from the release section if they are formed in one piece with the release section.

In an example, it is provided that one, multiple, or all of the insulation displacement arms may extend in a longitudinal direction, parallel to the cutting gap, beyond their respective cutting edge as far as an end face of the insulation displacement arm. Accordingly, the insulation displacement arm or arms do not end directly at their respective cutting edge but are slightly extended in their longitudinal direction. In this area, the insulation displacement arms can be designed without a cutting edge. In particular, the insulation displacement arms can be spaced so far apart in this area that an electrical conductor with a maximum conductor cross section, specified for the conductor connection terminal, can be inserted between the insulation displacement arms. This makes it possible for the electrical conductor to be guided further in the conductor insertion direction to the release element arranged behind the insulation displacement arms in order to actuate it with a pressure force.

The at least one holding device can be arranged on the insulation displacement connector. This has the advantage that the pressure spring and in particular the pressure section can be held directly in the pretensioned open position using the insulation displacement connector. Accordingly, no further components are required to realize the holding device. For example, the at least one holding device can be designed in the form of at least one end face of an insulation displacement arm. In this case, in the pretensioned open position, the pressure section can rest on the end face of an insulation displacement arm or the end faces of the insulation displacement arms.

The pressure spring held on the holding device can be released from the holding device when an electrical conductor to be clamped exerts an actuating force on the release element. The release of the clamping process of the electrical conductor on the insulation displacement connector can therefore be triggered directly by the electrical conductor itself when it is inserted into the insulation displacement connector in the conductor insertion direction and presses with its free end against the release element. An automatic connection function of the electrical conductor can be realized advantageously as a result.

The conductor connection terminal can have an insulating material housing which has at least one conductor insertion opening for receiving an electrical conductor in the conductor insertion direction, wherein the insulation displacement connector is arranged in the insulating material housing. The insulating material housing insulates the insulation displacement connector from the environment and protects it from environmental influences. In addition to the insulation displacement connector, other parts of the conductor connection terminal can also be arranged in the insulating material housing, in particular the pressure spring, the release element, and/or the outer spring.

The release element can be arranged behind the insulation displacement connector in the conductor insertion direction. This ensures that when the electrical conductor is inserted into the insulation displacement connector, the release element is actuated by the electrical conductor at a suitable moment in the insertion process, namely, when the electrical conductor is inserted far enough into the insulation displacement connector.

The insulation displacement connector can have a base section which is oriented at an angle, e.g., substantially at right angles, to the insulation displacement arms. The base section can be designed to support and/or fasten the insulation displacement connector in the insulating material housing. The base section can also have a solder contact section with which the insulation displacement connector can be soldered onto a printed circuit board, e.g., an SMD solder connection.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal in a perspective view in the open position;

FIG. 2 shows an example of a conductor connection terminal in a side view in the open position;

FIG. 3 shows the conductor connection terminal according to FIG. 2 in the clamping position; and

FIG. 4 shows the conductor connection terminal according to FIG. 3 in the sectional plane A-A.

### DETAILED DESCRIPTION

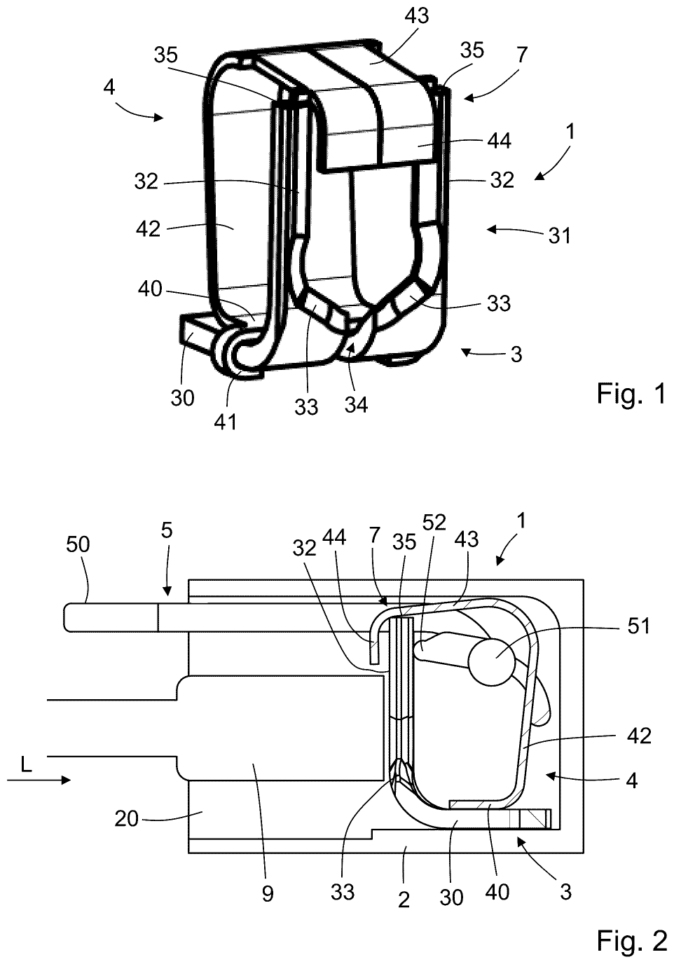

The conductor connection terminal 1 shown in FIG. 1 has an insulation displacement connector 3, a pressure spring 4, a holding device 7, and a release element 42. Insulation displacement connector 3 is designed as an angled sheet metal component that has a base section 30 and two cutting arms 32 which project from base section 30 at an angle and are arranged substantially parallel to each other. A cutting edge 33 of insulation displacement connector 3 is formed on each cutting arm 32. There is a, for example, V-shaped, cutting gap 34 between cutting edges 33. Cutting arms 32 extend beyond the respective cutting edge 33 to an end face 35. Cutting arms 32 are spaced apart in the upper area, i.e., between cutting edges 33 and end face 35, to such an extent that an electrical conductor can be inserted between them.

Pressure spring 4 is designed to press the electrical conductor into cutting gap 34 by means of the spring force. Pressure spring 4 has a pressure section 44 for this purpose, which is designed to come into direct contact with the electrical conductor in order to press it into cutting gap 34. Pressure spring 4 also has a fastening section 40, with which pressure spring 4 is connected to base section 30, e.g., by positive locking by means of tabs 41 of fastening section 40, tabs which are bent laterally around base section 30. Alternatively, pressure spring 4 can also be attached to another component of conductor connector terminal 1 via its fastening section 40.

Pressure spring 4 also has release section 42 as an integral structural unit, which forms a kind of rear wall of the arrangement shown. Pressure spring 4 thus extends in one piece from fastening section 40 to release section 42 and from there further in one piece to pressure section 44, wherein a holding section 43 can also be formed between release section 42 and pressure section 44.

Holding device 7 is used to hold pressure spring 4 in the open position, i.e., in a pretensioned state in which a spring force is present to press the electrical conductor into cutting gap 34. FIG. 1 also shows conductor connection terminal 1 in this open position. In the example shown, holding device 7 is formed by insulation displacement arms 32 and in particular their end faces 35. Pressure section 44 or holding section 43 of pressure spring 4, the holding section being connected to pressure section 44, is supported on end faces 35 of insulation displacement arms 32 under spring preload.

If an electrical conductor is now inserted into insulation displacement connector 3 through the free space between insulation displacement arms 32 above cutting edges 33 and pressed against release section 42, this causes a displacement of pressure section 44 and the possibly present holding section 43 in this conductor insertion direction, i.e., in the direction in which the electrical conductor is inserted between insulation displacement arms 32. Once a sufficient displacement of pressure section 44 has been achieved, pressure section 44 or holding section 43 detaches from end faces 35 and then moves downwards towards cutting edges 33 due to the spring preload. As a result, pressure section 44 presses the electrical conductor against cutting edges 33, as a result of which the insulation of the electrical conductor is cut open and the inner conductor makes electrical contact.

The conductor connection terminal 1 shown in FIG. 1 can also have an insulating material housing, although this is not shown in FIG. 1. An example of a conductor connection terminal 1 with an insulating material housing 2 is described with reference to FIGS. 2 to 4. Insulating material housing 2 has a conductor insertion opening 20. An electrical conductor 9 can be inserted into insulating material housing 2 through conductor insertion opening 20 in conductor insertion direction L and connected to insulation displacement connector 3.

Insulation displacement connector 3, pressure spring 4, and holding device 7 can, e.g., be designed similarly as described in FIG. 1. In addition, conductor connection terminal 1 can have an actuating element 5, e.g., in the form of an actuating lever or a push button, with which pressure spring 4 can be transferred to the open position, i.e., to the pretensioned state in which pressure section 44 or holding section 43 is held on holding device 7. FIG. 2 shows an example of actuating element 5 as a pivoting actuating lever. Actuating element 5 has a lever arm 50 with which the actuating lever can be operated manually by the user. Actuating element 5 can, for example, be pivotable about an axis of rotation 51. Actuating element 5 has a spring driver 52, which can press against holding section 43 with suitable manual actuation of actuating element 5 in order to move pressure spring 4 into the open position.

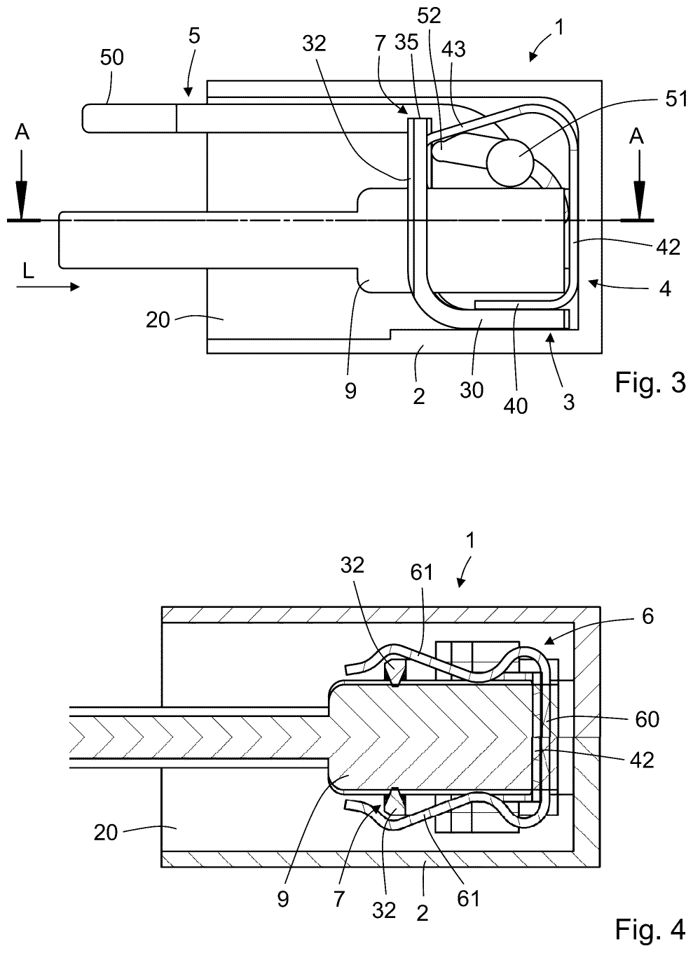

FIG. 2 shows conductor connection terminal 1 in the open position. Electrical conductor 9 is already slightly inserted into insulating material housing 2, but does not yet touch release section 42. FIG. 3 shows conductor connection terminal 1 according to FIG. 2 in the clamped position. Electrical conductor 9 has been pressed against release section 42, as a result of which holding section 43 has been released from holding device 7 and, accordingly, electrical conductor 9 has been pressed against cutting edges 33 by pressure section 44 due to the pretension of pressure spring 4.

FIG. 4 shows conductor connection terminal 1 according to FIG. 3 in a sectional plane A-A marked there. It can be seen that conductor connection terminal 1 can have an outer spring 6 as a further component, by means of which cutting arms 32 can be subjected to a spring force in directions pointing towards each other in order to ensure in this way the desired cutting pressure and contact pressure. For example, outer spring 6 can extend from a rear section 60, which can be attached to release section 42, in each case with a laterally arranged pressure tab 61 against the conductor insertion direction L to insulation displacement arms 32 and exert the aforementioned spring force on them. Outer spring 6 can also be formed in one piece with pressure spring 4, e.g., with release section 42. In this case, rear section 60 can be omitted. Pressure tabs 61 can then be formed directly in one piece with release section 42 and bent away from it.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A conductor connection terminal to connect an electrical conductor that is to be inserted into the conductor connection terminal in a conductor insertion direction, the conductor connection terminal comprising:
at least one insulation displacement connector with opposing cutting edges, between which a cutting gap is formed;
at least one pressure spring which is designed to press the electrical conductor into the cutting gap via a spring force;
at least one holder which is designed to hold the pressure spring in a pretensioned state in which a spring force is present for pressing the electrical conductor into the cutting gap; and
at least one release element, by actuation of which the pressure spring is released from the holder so that the electrical conductor is pressed into the cutting gap by its spring force,
wherein, by actuating the release element, at least part of the pressure spring is adapted to be displaced relative to the insulation displacement connector in the conductor insertion direction.

2. The conductor connection terminal according to claim 1, wherein the release element is formed as an integral structural unit with the pressure spring, or wherein the pressure spring is formed as a single-piece structural unit with the release element or as a sheet metal component.

3. The conductor connection terminal according to claim 1, wherein the pressure spring has a pressure section, which comes into contact with the electrical conductor in order to press it into the cutting gap, and a fastening section with which the pressure spring is fastened to a part of the insulation displacement connector or to another component of the conductor connection terminal.

4. The conductor connection terminal according to claim 3, wherein the release element is disposed between the fastening section and the pressure section.

5. The conductor connection terminal according to claim 3, wherein the pressure section is connected to the fastening section via the release element.

6. The conductor connection terminal according to claim 1, wherein the conductor connection terminal has an outer spring, via which the cutting edges are subjected to a spring force in directions pointing towards each other.

7. The conductor connection terminal according to claim 6, wherein the outer spring is formed in one piece with the pressure spring and/or the release section.

8. The conductor connection terminal according to claim 1, wherein the at least one holder is arranged on the insulation displacement connector.

9. The conductor connection terminal according to claim 1, wherein the insulation displacement connector has at least two insulation displacement arms, wherein a cutting edge of the insulation displacement connector is disposed on each insulation displacement arm.

10. The conductor connection terminal according to claim 8, wherein one, multiple, or all of the insulation displacement arms extend in a longitudinal direction, substantially parallel to the cutting gap, beyond their respective cutting edge as far as an end face of the insulation displacement arm.

11. The conductor connection terminal according to claim 9, wherein the at least one holder is designed in the form of at least one end face of an insulation displacement arm.

12. The conductor connection terminal according to claim 1, wherein the pressure spring (4) held on the holder is released from the holder when an electrical conductor to be clamped exerts an actuating force on the release element.

13. The conductor connection terminal according to claim 1, wherein the conductor connection terminal has an insulating material housing which has at least one conductor insertion opening for receiving an electrical conductor in the conductor insertion direction, and wherein the insulation displacement connector is arranged in the insulating material housing.

14. The conductor connection terminal according to claim 1, wherein the release element is arranged behind the insulation displacement connector in the conductor insertion direction.
